(19) United States
(12) Patent Application Publication
(10) Pub. No.: US 2014/0357237 A1
(43) Pub. Date: Dec. 4, 2014

(54) CUMULATIVE VOICEMAIL MESSAGE MANAGEMENT

(71) Applicant: International Business Machines Corporation, Armonk, NY (US)

(72) Inventors: Denise A. Bell, Austin, TX (US); Lisa Seacat DeLuca, Baltimore, MD (US); Jana H. Jenkins, Raleigh, NC (US)

(21) Appl. No.: 13/908,799

(22) Filed: Jun. 3, 2013

(51) Int. Cl. H04M 3/533; H04W 4/12

(52) U.S. Cl. CPC H04M 3/5335; H04W 4/12
USPC 455/413

(57) ABSTRACT

Configured called party-controlled voicemail reception preferences are obtained that allow a called party to control voicemail message recording by repeat callers that previously recorded an unheard voicemail message within a voice mailbox of the called party. An unanswered call to the called party by a caller is detected. A determination is made as to whether the voice mailbox of the called party includes an existing unheard previously-recorded voicemail message from the caller and that the caller is a repeat caller that is subject to the called party-controlled voicemail reception preferences. The voicemail message recording within the voice mailbox by the repeat caller is controlled using the configured called party-controlled voicemail reception preferences.

### BACKGROUND

The present invention relates to voicemail inbox management. More particularly, the present invention relates to cumulative voicemail message management.

Persons that call telephone users that have an available voicemail service may leave a voicemail message for the called telephone user if that user is not available to answer the telephone call. The called telephone user may listen to the voicemail message and may return the telephone call at a convenient time.

### BRIEF SUMMARY

A method includes obtaining, via a processor, configured called party-controlled voicemail reception preferences that allow a called party to control voicemail message recording by repeat callers that previously recorded an unheard voicemail message within a voice mailbox of the called party; detecting an unanswered call to the called party by a caller; determining that the voice mailbox of the called party comprises an existing unheard previously-recorded voicemail message from the caller and that the caller comprises a repeat caller subject to the called party-controlled voicemail reception preferences; and controlling voicemail message recording within the voice mailbox by the repeat caller using the configured called party-controlled voicemail reception preferences.

A system includes a memory, and a processor programmed to: obtain, from the memory, configured called party-controlled voicemail reception preferences that allow a called party to control voicemail message recording by repeat callers that previously recorded an unheard voicemail message within a voice mailbox of the called party; detect an unanswered call to the called party by a caller; determine that the voice mailbox of the called party comprises an existing unheard previously-recorded voicemail message from the caller and that the caller comprises a repeat caller subject to the called party-controlled voicemail reception preferences; and control voicemail message recording within the voice mailbox by the repeat caller using the configured called party-controlled voicemail reception preferences.

A computer program product includes a computer readable storage medium having computer readable program code embodied therewith, where the computer readable program code when executed on a computer causes the computer to: obtain configured called party-controlled voicemail reception preferences that allow a called party to control voicemail message recording by repeat callers that previously recorded an unheard voicemail message within a voice mailbox of the called party; detect an unanswered call to the called party by a caller; determine that the voice mailbox of the called party comprises an existing unheard previously-recorded voicemail message from the caller and that the caller comprises a repeat caller subject to the called party-controlled voicemail reception preferences; and control voicemail message recording within the voice mailbox by the repeat caller using the configured called party-controlled voicemail reception preferences.

### BRIEF DESCRIPTION OF THE SEVERAL VIEWS OF THE DRAWINGS

FIG. 1 is a block diagram of an example of an implementation of a system for cumulative voicemail message management according to an embodiment of the present subject matter;

FIG. 2 is a block diagram of an example of an implementation of a core processing module capable of performing cumulative voicemail message management according to an embodiment of the present subject matter;

FIG. 3 is a flow chart of an example of an implementation of a process for cumulative voicemail message management according to an embodiment of the present subject matter;

FIG. 4A is a flow chart of an example of an implementation of initial processing within a process for cumulative voicemail message management using an example set of called party-controlled voicemail reception preferences according to an embodiment of the present subject matter; and

FIG. 4B is a flow chart of an example of an implementation of additional processing within a process for cumulative voicemail message management using an example set of called party-controlled voicemail reception preferences according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides cumulative voicemail message management. The present technology manages voicemail messages where a first unheard voicemail message already exists from a caller and a subsequent new voicemail from the same caller is recorded. This subsequent/next voicemail message (e.g., voicemail message n+1) may be prepended/prefixed before the existing message (e.g., so that it is heard before), may be appended/postfixed after the existing message, may replace the existing voicemail message, or may modify the existing voicemail message. As such, both voicemail messages may be either aggregated together as a single or concatenated cumulative message, or the first message may be removed and replaced with the new voicemail message.

The present technology provides voice mailbox users with several new configurable voice mailbox preferences/options. For example, an “ignore” option represents an indication that a particular caller is optionally configured to not have the cumulative voicemail message management activated for calls from the particular person (e.g., family members, etc.). The ignore option may be maintained within a list of individuals/callers for which the cumulative voicemail message management described herein is optionally not configured/applicable.

Additionally, a “threshold activation” option may be specified as a configured option relative to a measured number of voicemail messages before the cumulative voicemail message management described herein is activated. Configurable options for the “threshold activation” option include immediate activation, activation on a per-caller basis after a configured number of messages (e.g., three (3) messages) from the same individual, and activation in response to the voice mailbox reaching a configured percentage of fullness (e.g., ninety percent (90%) full). As such, the threshold activation option may include a repeat caller-specific threshold activation option that activates the controlling of the voicemail message recording within the voice mailbox on an individual per-caller basis, or may include a global threshold activation option that activates the controlling of the voicemail message recording within the voice mailbox for all repeat callers.

Several “voicemail recording options” may also be provided. A “replace” recording option causes a new message from a repeat caller to replace a prior existing voicemail message. Optionally, the newly-recorded voicemail message may inherit the timestamp from the original previously-recorded voicemail message to allow the recipient to listen to the new message in the order that the original message was received.

A “prepend” voicemail recording option causes a new message from a repeat caller to be aggregated with one or more other existing unheard messages from that caller as a single message that is a concatenation of the new message followed by the prior existing message(s), where the new message is prepended (e.g., so that it is heard before) the prior existing voicemail message. The respective messages may be announced to indicate which of the merged messages is about to be played (e.g., “second message from caller,” followed by audio of the second voicemail message, then “first message from the same caller,” followed by audio of the first voicemail message). Similar processing may be performed for appending messages using an “append” voicemail recording option, where the new message is appended to the prior existing message. As with the prepend voicemail recording option, the respective appended messages may be announced to indicate which of the merged messages is about to be played (e.g., “first message from caller,” followed by audio of the first voicemail message, then “second message from the same caller,” followed by audio of the second voicemail message). As such, the recipient of the voicemail messages may receive audio feedback of the respective messages to differentiate and identify that the prepend or append recording option was utilized.

A “length-of-message” voicemail recording option may also be configured to allow a change with respect to configured options based upon the recorded length of a voicemail message (either single or combined/aggregated). For example, three (3) five (5) minute messages may be easier for the voicemail user to manage than one (1) fifteen (15) minute message.

A combination of any of the options discussed above may also be configured. For example, one caller may be specified by the voicemail user to be subject to the “threshold activation” option immediately (e.g., in response to a first call). Alternatively, another caller may be specified to be allowed to leave unlimited voicemail messages for the voicemail user. Many possibilities exist for voicemail management options based upon the description herein, and all such possibilities are considered to be within the scope of the present subject matter.

It should be noted that conception of the present subject matter resulted from recognition of certain limitations associated with voicemail inbox systems. For example, it was observed that a conventional voice mailbox may become full or extremely large such that an individual may find it very difficult to manage the number of messages as they are required to sort through an increasing number of voicemail messages. It was additionally observed that the user's voice mailbox may become locked, such that it prevents future messages from being delivered, until the user deletes older voicemail messages. It was additionally observed that circumstances that cause callers to leave voicemail messages may change from a time of an initial message until a later call in which the caller leaves a second message. For example, it was observed that in a case of an emergency, a caller may call to notify a voicemail recipient of the emergency (e.g., “It is an emergency, call me back as soon as possible!”). The caller may determine that the emergency is resolved, and call a second time to notify the user that the emergency is resolved (e.g., “Everything is okay. I found your pet and it is safe.”). It was determined that in such a situation, an ability to allow the caller to override the initial message would benefit the called voicemail recipient because the voicemail recipient would not have to learn of the emergency in one message and potentially have to search through multiple other messages to learn that the emergency has been resolved. It was further determined in view of these observations that new technology that allows repeat voicemail message callers to re-record, modify, and/or prepend a new voicemail message to an existing unheard voicemail message in the user's voice mailbox may improve voice mailbox processing by voicemail recipients. The present subject matter improves voicemail management by providing for cumulative voicemail message management, as described above and in more detail below. As such, improved voicemail management may be obtained through use of the present technology.

The cumulative voicemail message management described herein may be performed in real time to allow prompt management of voicemail inboxes. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

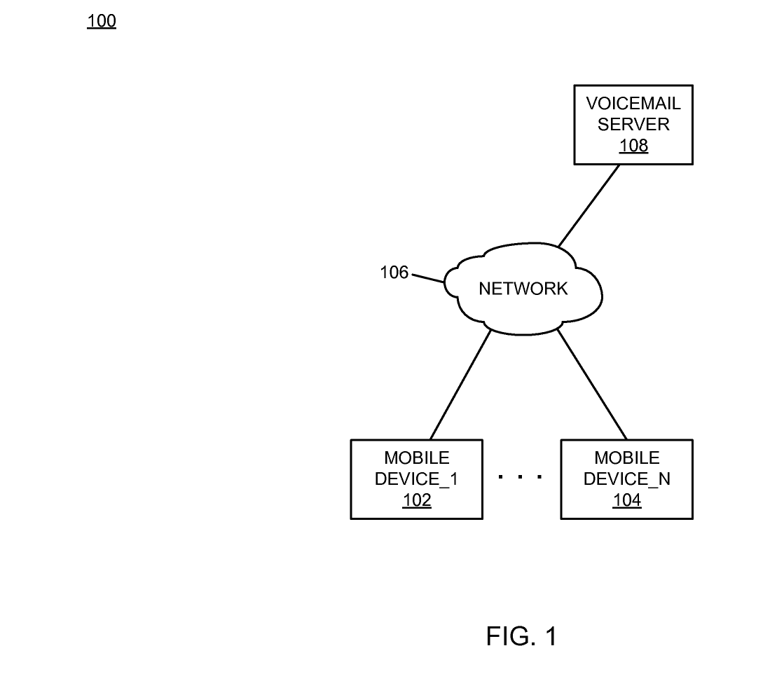

FIG. 1 is a block diagram of an example of an implementation of a system 100 for cumulative voicemail message management. A mobile device_{—}1 102 through a mobile device_N 104 communicate with each other via a network 106. The mobile device_{—}1 102 through the mobile device_N 104 generally represent telephone-capable devices, whether wireless/cellular devices, public switched telephone network (PSTN) capable devices, Internet phones, or other communications devices. Users of the mobile device_{—}1 102 through the mobile device_N 104 may place telephone calls to one another and may leave voicemail messages for one another using a voicemail server 108.

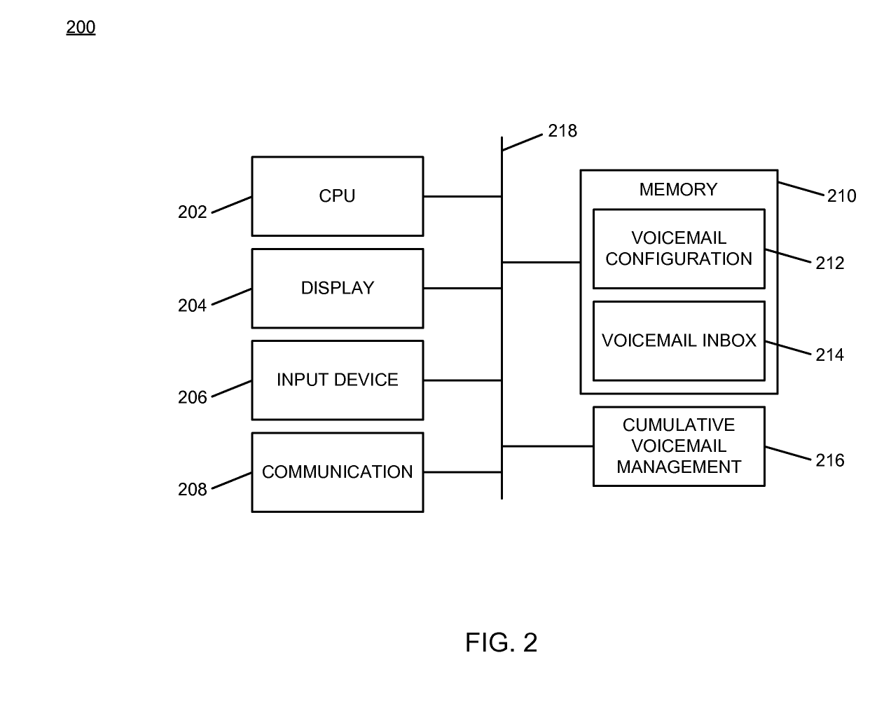

As will be described in more detail below in association with FIG. 2 through FIG. 4B, the mobile device_{—}1 102 through the mobile device_N 104 may each provide automated cumulative voicemail message management. The automated cumulative voicemail message management is based upon evaluation of incoming calls at a telephone or voicemail server, and a determination as to whether the current incoming caller has previously left one or more voicemail messages that have not yet been retrieved/listened to by the called party. Where a determination is made that the current incoming caller has previously left one or more voicemail messages that have not yet been retrieved/listened to by the called party, the automated cumulative voicemail message management is implemented as configured based upon the preferences of the called party, as described above and in more detail below. The present technology may be implemented at a user computing device or server device level. A variety of possibilities exist for implementation of the present subject matter, and all such possibilities are considered within the scope of the present subject matter.

It should be noted that any of the respective devices described in association with FIG. 1 may be portable computing devices, either by a user's ability to move the respective devices to different locations, or by the respective device's association with a portable platform, such as a plane, train, automobile, or other moving vehicle. It should also be noted that the respective devices may be any computing devices capable of processing information as described above and in more detail below. For example, the respective devices may include devices such as a personal computer (e.g., desktop, laptop, etc.) or a handheld device (e.g., cellular telephone, personal digital assistant (PDA), email device, tablet computing device, e-book reading device, etc.), a web server, application server, or other data server device, or any other device capable of processing information and placing/receiving telephone calls and/or voicemail messages as described above and in more detail below.

The network 106 may include any form of interconnection suitable for the intended purpose, including a private or public network such as an intranet or the Internet, respectively, direct inter-module interconnection, dial-up (e.g., public switched telephone network (PSTN)), wireless/cellular, or any other interconnection mechanism capable of interconnecting the respective devices.

The voicemail server 108 may include any device capable of providing data for consumption by a device, such as the mobile device_{—}1 102 through the mobile device_N 104, via a network, such as the network 106. As such, the voicemail server 108 may include a PSTN or cellular voicemail server, a web-based voicemail server, an application server, or other data server device.

FIG. 2 is a block diagram of an example of an implementation of a core processing module 200 capable of performing cumulative voicemail message management. The core processing module 200 may be associated with either the mobile device_{—}1 102 through the mobile device_N 104 or with the voicemail server 108, as appropriate for a given implementation. As such, the core processing module 200 is described generally herein, though it is understood that many variations on implementation of the components within the core processing module 200 are possible and all such variations are within the scope of the present subject matter.

Further, the core processing module 200 may provide different and complementary processing of voicemail messages in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 provides computer instruction execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, touchscreen, or any other type of input device by which the user may interact with and respond to information on the display 204.

It should be noted that the display 204 and the input device 206 may be optional components for the core processing module 200 for certain implementations/devices. Accordingly, the core processing module 200 may operate as a completely automated embedded device without direct user configurability or feedback. However, the core processing module 200 may also provide user feedback and configurability via the display 204 and the input device 206, respectively, as appropriate for a given implementation.

A communication module 208 provides interconnection capabilities that allow the core processing module 200 to communicate with other modules within the system 100. The communication module 208 may include any electrical, protocol, and protocol conversion capabilities useable to provide interconnection capabilities, appropriate for a given implementation.

A memory 210 includes a voicemail configuration storage area 212 that stores configured voice mailbox preferences/options in association with the core processing module 200. The voicemail configuration storage area 212 may store configured voice mailbox preferences/options for one or more users, as appropriate for the given implementation. As will be described in more detail below, configured voice mailbox preferences/options stored within the voicemail configuration storage area 212 is used to process incoming calls where a called party does not answer the incoming call and the calling party has already left at least one voicemail message that has not be heard/received by the called party.

The memory 210 also includes a voicemail inbox storage area 214 that may store one or more voicemail inboxes for one or more voicemail subscribers/users. The voicemail inboxes stored in the voicemail inbox storage area 214 may be processed using the configured voice mailbox preferences/options stored within the voicemail configuration storage area 212.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A cumulative voicemail management module 216 is also illustrated. The cumulative voicemail management module 216 provides integrated voicemail management across multiple calls and callers for the core processing module 200, as described above and in more detail below. The cumulative voicemail management module 216 implements the automated cumulative voicemail message management of the core processing module 200.

It should also be noted that the cumulative voicemail management module 216 may form a portion of other circuitry described without departure from the scope of the present subject matter. Further, the cumulative voicemail management module 216 may alternatively be implemented as an application stored within the memory 210. In such an implementation, the cumulative voicemail management module 216 may include instructions executed by the CPU 202 for performing the functionality described herein. The CPU 202 may execute these instructions to provide the processing capabilities described above and in more detail below for the core processing module 200. The cumulative voicemail management module 216 may form a portion of an interrupt service routine (ISR), a portion of an operating system, a portion of a browser application, or a portion of a separate application without departure from the scope of the present subject matter.

The CPU 202, the display 204, the input device 206, the communication module 208, the memory 210, and the cumulative voicemail management module 216 are interconnected via an interconnection 218. The interconnection 218 may include a system bus, a network, or any other interconnection capable of providing the respective components with suitable interconnection for the respective purpose.

Though the different modules illustrated within FIG. 2 are illustrated as component-level modules for ease of illustration and description purposes, it should be noted that these modules may include any hardware, programmed processor(s), and memory used to carry out the functions of the respective modules as described above and in more detail below. For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. For a distributed arrangement, the display 204 and the input device 206 may be located at a point of sale device, kiosk, or other location, while the CPU 202 and memory 210 may be located at a local or remote server. Many other possible arrangements for components of the core processing module 200 are possible and all are considered within the scope of the present subject matter. Accordingly, the core processing module 200 may take many forms and may be associated with many platforms.

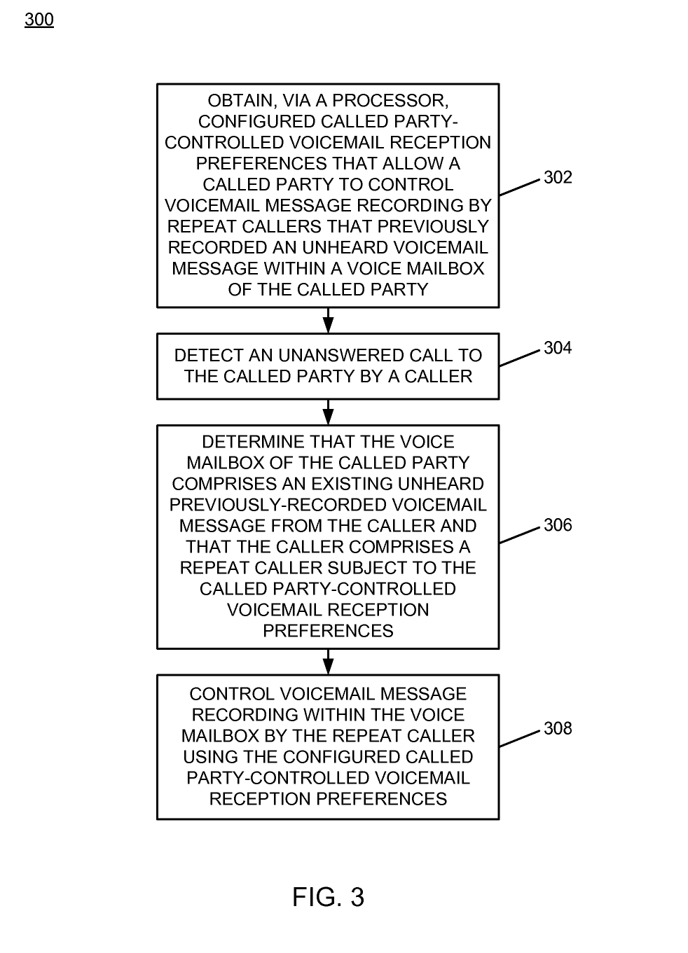

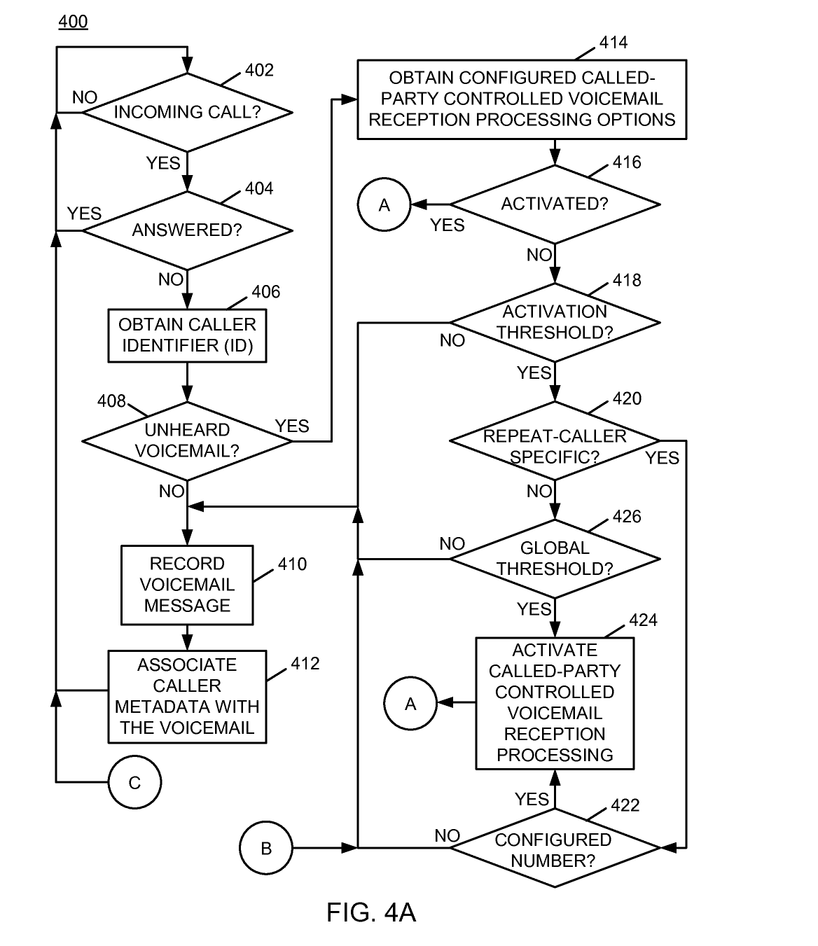

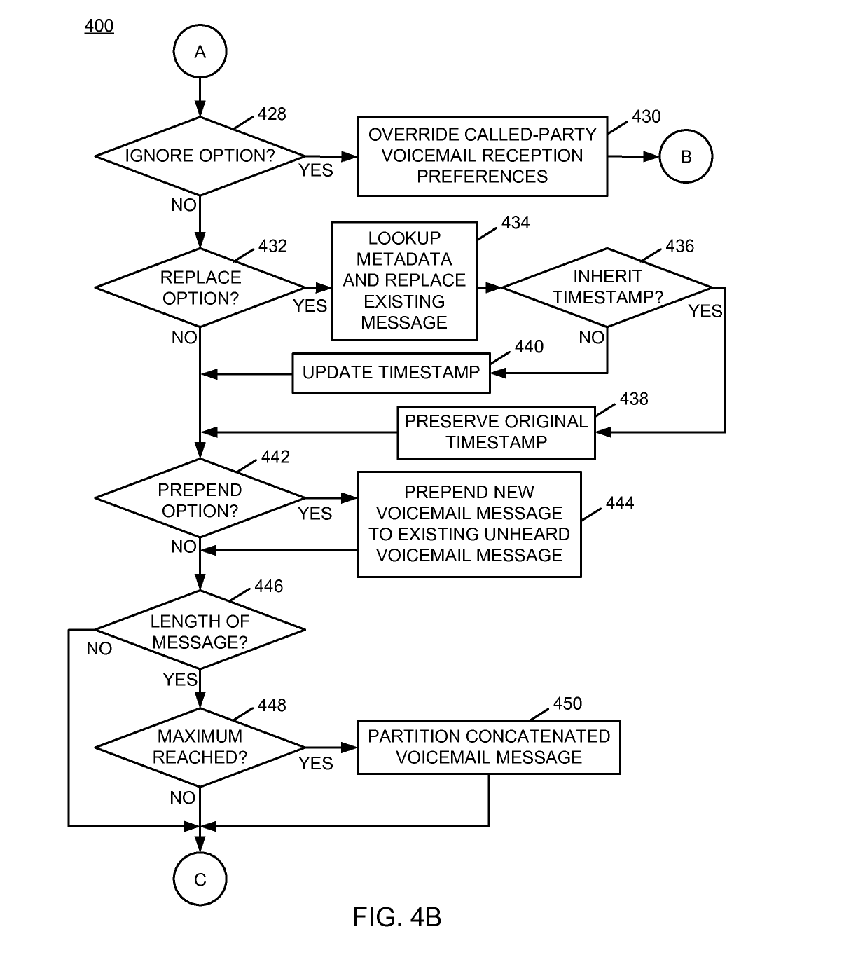

FIG. 3 through FIG. 4B described below represent example processes that may be executed by devices, such as the core processing module 200, to perform the automated cumulative voicemail message management associated with the present subject matter. Many other variations on the example processes are possible and all are considered within the scope of the present subject matter. The example processes may be performed by modules, such as the cumulative voicemail management module 216 and/or executed by the CPU 202, associated with such devices. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 3 is a flow chart of an example of an implementation of a process 300 for cumulative voicemail message management. At block 302, the process 300 obtains, via a processor, configured called party-controlled voicemail reception preferences that allow a called party to control voicemail message recording by repeat callers that previously recorded an unheard voicemail message within a voice mailbox of the called party. At block 304, the process 300 detects an unanswered call to the called party by a caller. At block 306, the process 300 determines that the voice mailbox of the called party comprises an existing unheard previously-recorded voicemail message from the caller and that the caller comprises a repeat caller subject to the called party-controlled voicemail reception preferences. At block 308, the process 300 controls voicemail message recording within the voice mailbox by the repeat caller using the configured called party-controlled voicemail reception preferences.

FIGS. 4A-4B illustrate a flow chart of an example of an implementation of process 400 for cumulative voicemail message management using an example set of called party-controlled voicemail reception preferences. FIG. 4A illustrates initial processing within the process 400. At decision point 402, the process 400 makes a determination as to whether an incoming telephone call to a called party (e.g., person, business, etc.) has been detected. In response to determining that an incoming telephone call to the called party has been detected, the process 400 makes a determination at decision point 404 as to whether the incoming telephone call has been answered by the called party. In response to determining that the incoming call has been answered by the called party, the process 400 returns to decision point 402 and iterates as described above.

In response to determining at decision point 404 that the incoming call has not been answered by the called party, the process 400 obtains a caller identification (ID) of the calling party (e.g., the “caller”) at block 406. Identification of the caller ID may be performed, for example, by evaluation of information received with the telephone call from the respective telephone system.

At decision point 408, the process 400 makes a determination as to whether there is an existing unheard previously-recorded voicemail message from the caller within the voice mailbox of the called party. The determination as to whether there is an existing unheard previously-recorded voicemail message from the caller within the voice mailbox of the called party may be performed, for example, using a lookup by associating metadata with the voicemail message, and determining whether there is a metadata match with the obtained caller ID. The associated metadata may include the caller's name, phone number, urgency, timestamp, length of message, or other metadata as appropriate for a given implementation. If an existing unheard previously-recorded voicemail message from the caller is within the voice mailbox of the called party, the calling party may be considered a repeat caller and may be subject to the called party-controlled voicemail reception preferences.

In response to a determination at decision point 408 that there is not an existing unheard previously-recorded voicemail message from the caller within the voice mailbox of the called party, the process 400 records the voicemail message within the voice mailbox of the called party at block 410. At block 412, the process 400 associates caller metadata with the recorded voicemail message. As described above, the associated metadata may include the caller's name, phone number, urgency, timestamp, length of message, or other metadata as appropriate for a given implementation to facilitate identification of repeat callers in response to future unanswered telephone calls. The metadata may be associated with the recorded voicemail message using tags, flags, data fields, or other identifiers as appropriate for a given implementation. The process 400 returns to decision point 402 and iterates as described above.

Returning to the description of decision point 408, in response to determining that there is an existing unheard previously-recorded voicemail message from the caller within the voice mailbox of the called party (and, as such, that the calling party may be considered a repeat caller subject to the called party-controlled voicemail reception preferences), at block 414 the process 400 obtains configured called party-controlled voicemail reception preferences that allow the called party to control voicemail message recording by repeat callers that previously recorded at least one unheard voicemail message within the voice mailbox of the called party. It should be noted that obtaining the configured called party-controlled voicemail reception preferences may include configuring the called party-controlled voicemail reception preferences as appropriate for a given implementation. Alternatively, the called party-controlled voicemail reception preferences may be configured locally or remotely (e.g., at a server) in advance, and the process 400 may retrieve the called party-controlled voicemail reception preferences from local or remote storage, again as appropriate for a given implementation. It should additionally be noted that certain of the called party-controlled voicemail reception preferences may be activated at a time of configuration (e.g., a configured ignore calling party recording option), while others may be configured with activation thresholds (e.g., a configured prepend voicemail recording option) that activate the respective called party-controlled voicemail reception preferences. Further, the activation thresholds may be repeat-caller specific or global thresholds, as appropriate for the particular implementation, and as described in more detail below.

At decision point 416, the process 400 makes a determination as to whether the called party-controlled voicemail reception preferences are already activated either globally or for this specific repeat caller. It should be noted as described above that the called party-controlled voicemail reception preferences may be activated on a per-caller basis or may be activated globally based upon the particular called party-controlled voicemail reception preferences that are configured. As such, the determination at decision point 416 may consider any of a variety of called party-controlled voicemail reception preferences. A detailed description of processing for an affirmative determination at decision point 416 and activated called party-controlled voicemail reception preferences will be deferred and described in more detail below to first describe activation of different forms of called party-controlled voicemail reception preferences.

As such, in response to determining at decision point 416 that the called party-controlled voicemail reception preferences are not already activated either globally or for this specific repeat caller, the process 400 makes a determination at decision point 418 as to whether either a global or repeat-caller specific activation threshold is configured to cause activation of one or more called party-controlled voicemail reception preferences. It should be noted that while the process 400 is depicted and described to utilize activation thresholds, other forms of processing and other called party-controlled voicemail reception preferences that do not utilize thresholds are possible and all such called party-controlled voicemail reception preferences are considered within the scope of the present subject matter.

In response to determining at decision point 418 that neither a global threshold nor a repeat-caller specific activation threshold is configured, the process 400 returns to block 410 to record a voicemail message from the caller and iterates as described above. In response to determining at decision point 418 that either a global or repeat-caller specific activation threshold is configured to cause activation of one or more called party-controlled voicemail reception preferences, the process 400 makes a determination at decision point 420 as to whether a repeat-caller specific threshold is configured for activation of the called party-controlled voicemail reception preferences.

In response to determining at decision point 420 that a repeat-caller specific threshold for this particular repeat caller is configured for activation of the called party-controlled voicemail reception preferences, the process 400 makes a determination at decision point 422 as to whether an individually-configured threshold number (e.g., two, three, etc.) of voicemail messages from this particular repeat caller have previously been recorded (e.g., the individual threshold has been reached or exceeded) and remain unheard in the voice mailbox of the called party. In response to determining at decision point 422 that the configured threshold number (e.g., two, three, etc.) of voicemail messages from this particular repeat caller have previously been recorded and remain unheard in the voice mailbox of the called party, the process 400 activates the called party-controlled voicemail reception preferences applicable to this particular repeat caller at block 424. Additional processes subsequent to activation of the called party-controlled voicemail reception preferences applicable to this particular repeat caller at block 424 will be deferred and described in more detail below. In response to determining at decision point 422 that the configured threshold number (e.g., two, three, etc.) of voicemail messages from this particular repeat caller have not previously been recorded or do not remain unheard in the voice mailbox of the called party, the process 400 returns to block 410 to record a voicemail message from the caller and iterates as described above.

Returning to the description of decision point 420, in response to determining that a repeat-caller specific threshold for this particular repeat caller is not configured for activation of the called party-controlled voicemail reception preferences, the process 400 makes a determination at decision point 426 as to whether a configured global threshold for activation of the called party-controlled voicemail reception preferences has been reached (or exceeded as appropriate for the particular implementation). It should be noted that there are several possibilities for global activation of the called party-controlled voicemail reception preferences. For example, a percentage of fullness of the called party's voice mailbox (e.g., ninety percent (90%) full) may be utilized to cause activation of the called party-controlled voicemail reception preferences. Other possible global activation thresholds are possible, and all such possibilities are considered to be within the scope of the present technology.

In response to determining at decision point 426 that a configured global threshold for activation of the called party-controlled voicemail reception preferences has been reached (or exceeded as appropriate for the particular implementation), the process 400 activates the called party-controlled voicemail reception preferences for the called party's voice mailbox at block 424 as described above. Again, additional processes subsequent to activation of the called party-controlled voicemail reception preferences applicable to this particular repeat caller at block 424 will be deferred and described in more detail below. In response to determining at decision point 426 that a configured global threshold for activation of the called party-controlled voicemail reception preferences has not been reached (or has not exceeded as appropriate for the particular implementation), the process 400 returns to block 410 to record a voicemail message from the caller and iterates as described above.

Processing of activated called party-controlled voicemail reception preferences will now be described. As such, returning to the description of decision point 416, in response to determining that the called party-controlled voicemail reception preferences are already activated either globally or for this specific repeat caller, or in response to completion of the processing to activate the called party-controlled voicemail reception preferences applicable to this particular repeat caller at block 424, the process 400 transitions to the processing shown and described in association with FIG. 4B.

FIG. 4B illustrates additional processing associated with the process 400 for cumulative voicemail message management using an example set of called party-controlled voicemail reception preferences. At decision point 428, the process 400 makes a determination as to whether the repeat caller is an identified repeat caller configured with an ignore calling party recording option. For example, the process 400 may evaluate an ignore list that includes identifiers of parties (e.g., family members, etc.) for which to override the called party-controlled voicemail reception preferences. As described above, a configured ignore calling party recording option may be used to override the configured called party-controlled voicemail reception preferences based upon repeat caller identities. In response to determining that the repeat caller is an identified repeat caller configured with the ignore calling party recording option, the process 400 overrides the configured called party-controlled voicemail reception preferences for this particular identified repeat caller at block 430. The process 400 returns to the processing described in association with FIG. 4A at block 410 to record a voicemail message from the caller and iterates as described above.

Returning to the description of decision point 428, in response to determining that the repeat caller is not an identified repeat caller configured with an ignore calling party recording option, the process 400 makes a determination at decision point 432 as to whether a replace recording option has been configured (again either globally or for this particular repeat caller). As described above, a newly-recorded voicemail message may optionally inherit the timestamp from the original previously-recorded voicemail message to allow the recipient to listen to the new message in the order that the original message was received. In response to determining that the replace recording option has been configured, the process 400 performs a lookup of metadata (e.g., by caller ID) and replaces at least one existing previously-recorded voicemail message that matches the metadata with a newly-recorded voicemail message at block 434.

At decision point 436, the process 400 makes a determination as to whether the configured replace recording option is further configured to cause a timestamp of the replaced voicemail message to be inherited by the new voicemail message. In response to determining that the configured replace recording option is further configured to cause the timestamp of the replaced voicemail message to be inherited by the new voicemail message, the process 400 preserves the original timestamp of the replaced voicemail message for the newly-recorded voicemail message at block 438. In response to determining that the configured replace recording option is not further configured to cause the timestamp of the replaced voicemail message to be inherited by the new voicemail message, the process 400 updates the timestamp for the newly-recorded voicemail message at block 440.

In response to either preserving the original timestamp of the replaced voicemail message for the newly-recorded voicemail message at block 438, updating the timestamp for the newly-recorded voicemail message at block 440, or determining at decision point 432 that the replace recording option has not been configured, the process 400 makes a determination at decision point 442 as to whether a prepend voicemail recording option has been configured (again either globally or for this particular repeat caller). A prepend voicemail recording option may be configured to cause a new voicemail message from a repeat caller to be aggregated together with a previously-recorded voicemail message as a single message that is a concatenation of the new message followed with one or more existing prior unheard previously-recorded voicemail messages. As such, the new message may be heard by the called party before one or more existing prior unheard previously-recorded voicemail messages. It should be noted that an “append” recording option is also possible and considered to be an additional part of the process 400, but is omitted from the drawing to avoid crowding within the drawing figure.

In response to determining that the prepend voicemail recording option has been configured at decision point 442, the process 400 pretends a new voicemail message recorded by the repeat caller to the existing prior unheard previously-recorded voicemail message from the repeat caller at block 444. As described above, the new voicemail message may be heard before the existing prior unheard previously-recorded voicemail message.

In response to either pretending a new voicemail message recorded by the repeat caller to the existing prior unheard previously-recorded voicemail message from the repeat caller at block 444, or in response to determining at decision point 442 that the prepend voicemail recording option has not been configured, the process 400 makes a determination at decision point 446 as to whether a length-of-message voicemail recording option has been configured (again either globally or for this particular repeat caller). The length-of-message voicemail recording option may be used to cause partitioning of individual concatenated voicemail messages into multiple voicemail messages based upon a configured maximum length of voicemail messages from individual repeat callers.

In response to determining that the length-of-message voicemail recording option has been configured at decision point 446, the process 400 makes a determination at decision point 448 as to whether a configured maximum length of the voicemail messages from the repeat caller has been reached by a concatenated voicemail message. In response to determining that the configured maximum length of the voicemail messages from the repeat caller has been reached by a concatenated voicemail message, the process 400 partitions the concatenated voicemail message into at least two voicemail messages at block 450. In response to partitioning the concatenated voicemail message into at least two voicemail messages at block 450, or in response to determining that the configured maximum length of the voicemail messages from the repeat caller has not been reached by a concatenated voicemail message, or in response to determining that the length-of-message voicemail recording option has not been configured at decision point 446, the process 400 returns to the processing described in association with FIG. 4A at decision point 402 and iterates as described above.

As such, the process 400 processes unanswered telephone calls and performs a variety of processing options in response to determining that at least one unheard voicemail message from a repeat caller exists within a voice mailbox of the called party. The process 400 may configure called party-controlled voicemail reception preferences either globally or on an individual repeat-caller basis. The process 400 obtains configured called party-controlled voicemail reception preferences that, for purposes of example, include an ignore calling party recording option, a replace recording option that allows timestamp inheritance, a prepend voicemail recording that concatenates messages and allows the latter message to be heard first, and a length-of-message voicemail recording option that may partition concatenated messages for ease of review. These example configured called party-controlled voicemail reception preferences may be expanded to include other configured called party-controlled voicemail reception preferences, and any such configured called party-controlled voicemail reception preferences are considered to be within the scope of the present subject matter.

As described above in association with FIG. 1 through FIG. 4B, the example systems and processes provide cumulative voicemail message management. Many other variations and additional activities associated with cumulative voicemail message management are possible and all are considered within the scope of the present subject matter.

Those skilled in the art will recognize, upon consideration of the above teachings, that certain of the above examples are based upon use of a programmed processor, such as the CPU 202. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
obtaining, via a processor, configured called party-controlled voicemail reception preferences that allow a called party to control voicemail message recording by repeat callers that previously recorded an unheard voicemail message within a voice mailbox of the called party;
detecting an unanswered call to the called party by a caller;
determining that the voice mailbox of the called party comprises an existing unheard previously-recorded voicemail message from the caller and that the caller comprises a repeat caller subject to the called party-controlled voicemail reception preferences; and
controlling voicemail message recording within the voice mailbox by the repeat caller using the configured called party-controlled voicemail reception preferences.

2. The method of claim 1, where obtaining, via the processor, the configured called party-controlled voicemail reception preferences that allow the called party to control the voicemail message recording by the repeat callers that previously recorded the unheard voicemail message within the voice mailbox of the called party comprises:
obtaining a configured threshold activation option that activates the controlling of the voicemail message recording within the voice mailbox in response to a configured voicemail threshold being reached.

3. The method of claim 2, where:
the configured threshold activation option comprises a configured repeat caller-specific threshold activation option that activates the controlling of the voicemail message recording within the voice mailbox on an individual per-caller basis after an individually-configured number of voicemail messages from the same repeat caller has been reached; and
controlling the voicemail message recording within the voice mailbox by the repeat caller using the configured called party-controlled voicemail reception preferences comprises:
determining whether the individually-configured number of voicemail messages from the same repeat caller has been reached; and
activating the configured called party-controlled voicemail reception preferences for the same repeat caller in response to determining that the individually-configured number of voicemail messages from the same repeat caller has been reached.

4. The method of claim 2, where:
the configured threshold activation option comprises a configured global threshold activation option that activates the controlling of the voicemail message recording within the voice mailbox for all repeat callers in response to the voice mailbox reaching a configured percentage of fullness; and
controlling the voicemail message recording within the voice mailbox by the repeat caller using the configured called party-controlled voicemail reception preferences comprises:
determining whether the configured percentage of fullness of the voice mailbox has been reached; and
activating the configured called party-controlled voicemail reception preferences for all repeat callers in response to determining that the configured percentage of fullness of the voice mailbox has been reached.

5. The method of claim 1, where:
obtaining, via the processor, the configured called party-controlled voicemail reception preferences that allow the called party to control the voicemail message recording by the repeat callers that previously recorded the unheard voicemail message within the voice mailbox of the called party comprises:
obtaining a configured prepend voicemail recording option that causes a new voicemail message from the repeat caller to be aggregated together with at least one existing unheard previously-recorded voicemail message as a single message that comprises a concatenation of the new message followed with the at least one existing unheard previously-recorded voicemail message, where the new message is heard by the called party before the at least one existing unheard previously-recorded voicemail message; and
controlling the voicemail message recording within the voice mailbox by the repeat caller using the configured called party-controlled voicemail reception preferences comprises:
pretending the new voicemail message recorded by the repeat caller to the at least one existing unheard previously-recorded voicemail message from the repeat caller.

6. The method of claim 1, where:
obtaining, via the processor, the configured called party-controlled voicemail reception preferences that allow the called party to control the voicemail message recording by the repeat callers that previously recorded the unheard voicemail message within the voice mailbox of the called party comprises:
obtaining a configured length-of-message voicemail recording option that partitions individual concatenated voicemail messages into multiple voicemail messages based upon a configured maximum length of voicemail messages from individual repeat callers; and
controlling the voicemail message recording within the voice mailbox by the repeat caller using the configured called party-controlled voicemail reception preferences comprises:
determining that the configured maximum length of the voicemail messages from the repeat caller has been reached by a concatenated voicemail message; and
partitioning the concatenated voicemail message into at least two voicemail messages.

7. The method of claim 1, where:
obtaining, via the processor, the configured called party-controlled voicemail reception preferences that allow the called party to control the voicemail message recording by the repeat callers that previously recorded the unheard voicemail message within the voice mailbox of the called party comprises:
obtaining a configured ignore calling party recording option that overrides the configured called party-controlled voicemail reception preferences based upon repeat caller identities; and
controlling the voicemail message recording within the voice mailbox by the repeat caller using the configured called party-controlled voicemail reception preferences comprises:
determining that the repeat caller comprises an identified repeat caller configured with the ignore calling party recording option; and
overriding the configured called party-controlled voicemail reception preferences for the identified repeat caller configured with the ignore calling party recording option.

8. A system, comprising:
a memory; and
a processor programmed to:
obtain, from the memory, configured called party-controlled voicemail reception preferences that allow a called party to control voicemail message recording by repeat callers that previously recorded an unheard voicemail message within a voice mailbox of the called party;
detect an unanswered call to the called party by a caller;
determine that the voice mailbox of the called party comprises an existing unheard previously-recorded voicemail message from the caller and that the caller comprises a repeat caller subject to the called party-controlled voicemail reception preferences; and
control voicemail message recording within the voice mailbox by the repeat caller using the configured called party-controlled voicemail reception preferences.

9. The system of claim 8, where, in being programmed to:
obtain, from the memory, the configured called party-controlled voicemail reception preferences that allow the called party to control the voicemail message recording by the repeat callers that previously recorded the unheard voicemail message within the voice mailbox of the called party, the processor is programmed to:
obtain a configured threshold activation option that activates the controlling of the voicemail message recording within the voice mailbox in response to a configured voicemail threshold being reached, where the configured threshold activation option comprises a configured repeat caller-specific threshold activation option that activates the controlling of the voicemail message recording within the voice mailbox on an individual per-caller basis after an individually-configured number of voicemail messages from the same repeat caller has been reached; and
control the voicemail message recording within the voice mailbox by the repeat caller using the configured called party-controlled voicemail reception preferences, the processor is programmed to:
determine whether the individually-configured number of voicemail messages from the same repeat caller has been reached; and
activate the configured called party-controlled voicemail reception preferences for the same repeat caller in response to determining that the individually-configured number of voicemail messages from the same repeat caller has been reached.

10. The system of claim 8, where, in being programmed to:
obtain, from the memory, the configured called party-controlled voicemail reception preferences that allow the called party to control the voicemail message recording by the repeat callers that previously recorded the unheard voicemail message within the voice mailbox of the called party, the processor is programmed to:
obtain a configured threshold activation option that activates the controlling of the voicemail message recording within the voice mailbox in response to a configured voicemail threshold being reached, where the configured threshold activation option comprises a configured global threshold activation option that activates the controlling of the voicemail message recording within the voice mailbox for all repeat callers in response to the voice mailbox reaching a configured percentage of fullness; and
control the voicemail message recording within the voice mailbox by the repeat caller using the configured called party-controlled voicemail reception preferences, the processor is programmed to:
determine whether the configured percentage of fullness of the voice mailbox has been reached; and
activate the configured called party-controlled voicemail reception preferences for all repeat callers in response to determining that the configured percentage of fullness of the voice mailbox has been reached.

11. The system of claim 8, where, in being programmed to:
obtain, from the memory, the configured called party-controlled voicemail reception preferences that allow the called party to control the voicemail message recording by the repeat callers that previously recorded the unheard voicemail message within the voice mailbox of the called party, the processor is programmed to:
obtain a configured prepend voicemail recording option that causes a new voicemail message from the repeat caller to be aggregated together with at least one existing unheard previously-recorded voicemail message as a single message that comprises a concatenation of the new message followed with the at least one existing unheard previously-recorded voicemail message, where the new message is heard by the called party before the at least one existing unheard previously-recorded voicemail message; and
control the voicemail message recording within the voice mailbox by the repeat caller using the configured called party-controlled voicemail reception preferences, the processor is programmed to:
prepend the new voicemail message recorded by the repeat caller to the at least one existing unheard previously-recorded voicemail message from the repeat caller.

12. The system of claim 8, where, in being programmed to:
obtain, from the memory, the configured called party-controlled voicemail reception preferences that allow the called party to control the voicemail message recording by the repeat callers that previously recorded the unheard voicemail message within the voice mailbox of the called party, the processor is programmed to:
obtain a configured length-of-message voicemail recording option that partitions individual concatenated voicemail messages into multiple voicemail messages based upon a configured maximum length of voicemail messages from individual repeat callers; and
control the voicemail message recording within the voice mailbox by the repeat caller using the configured called party-controlled voicemail reception preferences, the processor is programmed to:
determine that the configured maximum length of the voicemail messages from the repeat caller has been reached by a concatenated voicemail message; and
partition the concatenated voicemail message into at least two voicemail messages.

13. The system of claim 8, where, in being programmed to:
obtain, from the memory, the configured called party-controlled voicemail reception preferences that allow the called party to control the voicemail message recording by the repeat callers that previously recorded the unheard voicemail message within the voice mailbox of the called party, the processor is programmed to:
obtain a configured ignore calling party recording option that overrides the configured called party-controlled voicemail reception preferences based upon repeat caller identities; and
control the voicemail message recording within the voice mailbox by the repeat caller using the configured called party-controlled voicemail reception preferences, the processor is programmed to:
determine that the repeat caller comprises an identified repeat caller configured with the ignore calling party recording option; and
override the configured called party-controlled voicemail reception preferences for the identified repeat caller configured with the ignore calling party recording option.

14. A computer program product, comprising:
a computer readable storage medium having computer readable program code embodied therewith, where the computer readable program code when executed on a computer causes the computer to:
obtain configured called party-controlled voicemail reception preferences that allow a called party to control voicemail message recording by repeat callers that previously recorded an unheard voicemail message within a voice mailbox of the called party;
detect an unanswered call to the called party by a caller;
determine that the voice mailbox of the called party comprises an existing unheard previously-recorded voicemail message from the caller and that the caller comprises a repeat caller subject to the called party-controlled voicemail reception preferences; and
control voicemail message recording within the voice mailbox by the repeat caller using the configured called party-controlled voicemail reception preferences.

15. The computer program product of claim 14, where, in causing the computer to obtain the configured called party-controlled voicemail reception preferences that allow the called party to control the voicemail message recording by the repeat callers that previously recorded the unheard voicemail message within the voice mailbox of the called party, the computer readable program code when executed on the computer causes the computer to:
obtain a configured threshold activation option that activates the controlling of the voicemail message recording within the voice mailbox in response to a configured voicemail threshold being reached.

16. The computer program product of claim 15, where:
the configured threshold activation option comprises a configured repeat caller-specific threshold activation option that activates the controlling of the voicemail message recording within the voice mailbox on an individual per-caller basis after an individually-configured number of voicemail messages from the same repeat caller has been reached; and
in causing the computer to control the voicemail message recording within the voice mailbox by the repeat caller using the configured called party-controlled voicemail reception preferences, the computer readable program code when executed on the computer causes the computer to:
determine whether the individually-configured number of voicemail messages from the same repeat caller has been reached; and
activate the configured called party-controlled voicemail reception preferences for the same repeat caller in response to determining that the individually-configured number of voicemail messages from the same repeat caller has been reached.

17. The computer program product of claim 15, where:
the configured threshold activation option comprises a configured global threshold activation option that activates the controlling of the voicemail message recording within the voice mailbox for all repeat callers in response to the voice mailbox reaching a configured percentage of fullness; and
in causing the computer to controlling the voicemail message recording within the voice mailbox by the repeat caller using the configured called party-controlled voicemail reception preferences, the computer readable program code when executed on the computer causes the computer to:
determine whether the configured percentage of fullness of the voice mailbox has been reached; and
activate the configured called party-controlled voicemail reception preferences for all repeat callers in response to determining that the configured percentage of fullness of the voice mailbox has been reached.

18. The computer program product of claim 14, where, in causing the computer to:
obtain the configured called party-controlled voicemail reception preferences that allow the called party to control the voicemail message recording by the repeat callers that previously recorded the unheard voicemail message within the voice mailbox of the called party, the computer readable program code when executed on the computer causes the computer to:
obtain a configured prepend voicemail recording option that causes a new voicemail message from the repeat caller to be aggregated together with at least one existing unheard previously-recorded voicemail message as a single message that comprises a concatenation of the new message followed with the at least one existing unheard previously-recorded voicemail message, where the new message is heard by the called party before the at least one existing unheard previously-recorded voicemail message; and
control the voicemail message recording within the voice mailbox by the repeat caller using the configured called party-controlled voicemail reception preferences, the computer readable program code when executed on the computer causes the computer to:
prepend the new voicemail message recorded by the repeat caller to the at least one existing unheard previously-recorded voicemail message from the repeat caller.

19. The computer program product of claim 14, where, in causing the computer to:
obtain the configured called party-controlled voicemail reception preferences that allow the called party to control the voicemail message recording by the repeat callers that previously recorded the unheard voicemail message within the voice mailbox of the called party, the computer readable program code when executed on the computer causes the computer to:
obtain a configured length-of-message voicemail recording option that partitions individual concatenated voicemail messages into multiple voicemail messages based upon a configured maximum length of voicemail messages from individual repeat callers; and
control the voicemail message recording within the voice mailbox by the repeat caller using the configured called party-controlled voicemail reception preferences, the computer readable program code when executed on the computer causes the computer to:
determine that the configured maximum length of the voicemail messages from the repeat caller has been reached by a concatenated voicemail message; and
partition the concatenated voicemail message into at least two voicemail messages.

20. The computer program product of claim 14, where, in causing the computer to:
obtain the configured called party-controlled voicemail reception preferences that allow the called party to control the voicemail message recording by the repeat callers that previously recorded the unheard voicemail message within the voice mailbox of the called party, the computer readable program code when executed on the computer causes the computer to:
obtain a configured ignore calling party recording option that overrides the configured called party-controlled voicemail reception preferences based upon repeat caller identities; and
control the voicemail message recording within the voice mailbox by the repeat caller using the configured called party-controlled voicemail reception preferences, the computer readable program code when executed on the computer causes the computer to:
determine that the repeat caller comprises an identified repeat caller configured with the ignore calling party recording option; and
override the configured called party-controlled voicemail reception preferences for the identified repeat caller configured with the ignore calling party recording option.
